(19) United States
(12) Patent Application Publication
(10) Pub. No.: US 2018/0176285 A1
(43) Pub. Date: Jun. 21, 2018

(54) ENHANCED TRANSMISSION OF MEDIA TO CLIENT DEVICES

(71) Applicant: The DIRECTV Group, Inc., El Segundo, CA (US)

(72) Inventors: Binny Asarikuniyil, Cerritos, CA (US); Atanu Basak, Torrance, CA (US)

(21) Appl. No.: 15/380,187

(22) Filed: Dec. 15, 2016

(51) Int. Cl. H04L 29/08; H04L 29/06

(52) U.S. Cl. CPC H04L 67/06; H04L 67/42; H04L 65/607; H04L 65/601

(57) ABSTRACT

A method and system for enhance transmission of media to client devices. A request is received from a client device to stream at least one media file, wherein the request has an associated client storage parameter. The at least one media file is identified in a memory storage device. It is determined whether or not the at least one media file satisfies the client storage parameter. if the at least one media file does not satisfy the client storage parameter, another media file is generated that does satisfy the client storage parameter. One of the at least one media file and the other media file is sent in accordance with determining if the at least one media file satisfies the client storage parameter.

### FIELD OF INVENTION

This disclosure generally relates to transmission of media to client devices, and more particularly to improving transmission of media to client devices.

### BACKGROUND

Mobile devices are commonly used to consume media files, such as audio and video files. Consumption occurs through the use of streaming wherein media files are transmitted from a network server to a mobile device in a more or less real time fashion. However, media streaming only works if there is a data connection between the mobile device and the network server. If there is no data connection, then the user will not be able to stream media.

Accordingly, rather than relying solely on streaming, many users anticipate when they will be in areas of low or no network connectivity and download media files prior to losing network connectivity. The media files can then be consumed at a later time from local storage. A difficulty arises, however, in that many devices have limited storage capacity. When a user attempts to download a media file without sufficient storage, the user is given an error message stating that the device has insufficient storage to download the file. The user then has to free storage before resuming the download process. Therefore, what is needed is a system and method for improving the transmission of media to client devices.

### SUMMARY

In embodiments, non-transitory computer readable media can store instructions for performing or causing aspects disclosed herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

In one embodiment a method is provided. A request from a client device to stream at least one media file is received. The request has an associated client storage parameter. The at least one media file in a memory storage device is identified. It is determined whether or not the at least one media file satisfies the client storage parameter. If the at least one media file does not satisfy the client storage parameter, another media file is generated that does satisfy the client storage parameter. One of the at least one media file and the other media file is sent in accordance with determining if the at least one media file satisfies the client storage parameter.

In one embodiment, a media server run by a processor and stored on a non-transitory computer readable medium is provided. A module receives a request from a client device to stream at least one media file, wherein the request has an associated client storage parameter. A module identifies the at least one media file in a memory storage device. A module determines whether or not the at least one media file satisfies the client storage parameter. A module generates another media file that does satisfy the client storage parameter if the at least one media file does not satisfy the client storage parameter. A module sends one of the at least one media file and the other media file in accordance with determining if the at least one media file satisfies the client storage parameter.

In another embodiment a system is provided. A device includes a processor and instructions stored on a non-transitory computer readable medium, the instructions when executed perform a method. A request is received from a client device to stream at least one media file, wherein the request has an associated client storage parameter. The at least one media file is identified in a memory storage device. It is determined whether or not the at least one media file satisfies the client storage parameter. If the at least one media file does not satisfy the client storage parameter, another media file is generated that does satisfy the client storage parameter. One of the at least one media file and the other media file is sent in accordance with determining if the at least one media file satisfies the client storage parameter.

### BRIEF DESCRIPTION OF THE DRAWINGS

Aspects of the herein described systems and methods are described more fully with reference to the accompanying drawings, which provide examples. In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1 illustrates an exemplary system for transmitting media to a client device.

FIG. 2 illustrates an exemplary method for transmitting media to a client device.

FIG. 3 illustrates an example computing environment for the system and method of FIGS. 1 and 2.

### DETAILED DESCRIPTION

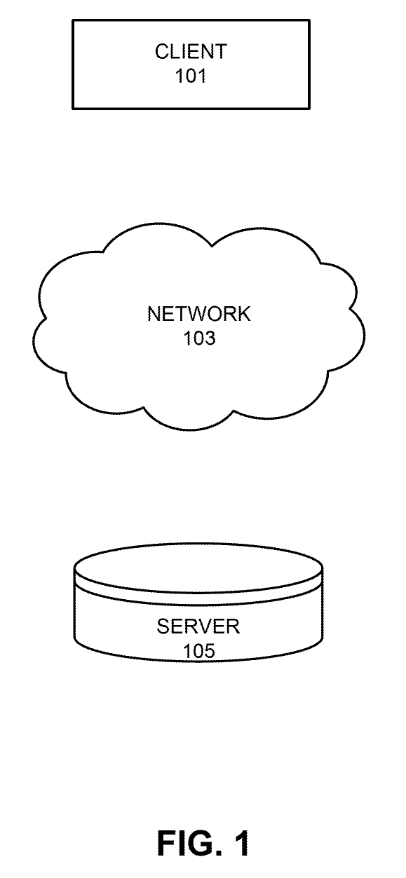

Referring to FIG. 1, one example of a system 100 for transmitting media is provided for exemplary purposes.

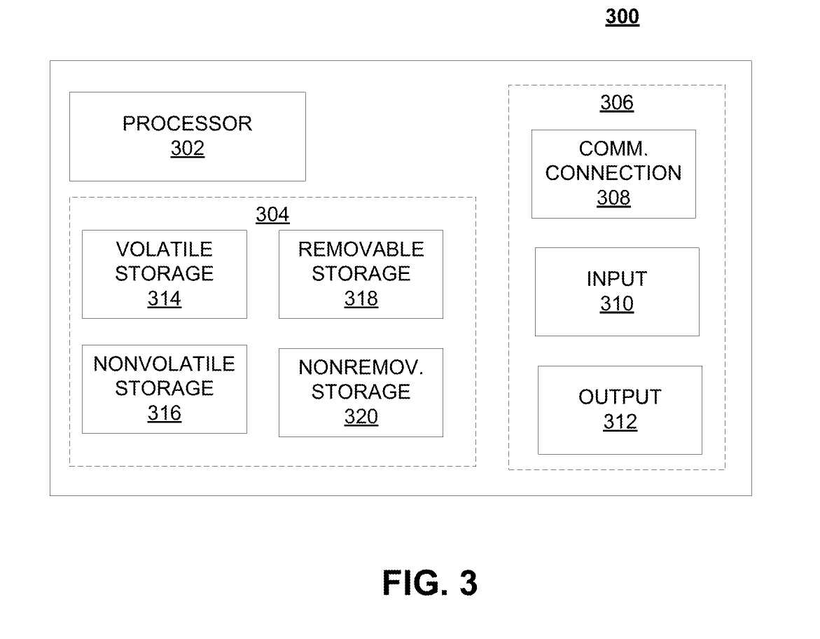

System 100 in one embodiment comprises a client device 101, a network 103, and a server 105. An exemplary description of possible embodiments of client device 101 and server 105 are illustrated and described with respect to FIG. 3.

The network 103, in one example, may be a fixed network, e.g., Ethernet, Fiber, ISDN, PLC, or the like or a wireless network, e.g., WLAN, cellular, or the like, or a network of heterogeneous networks. For example, the network 103 may comprise of multiple access networks that provides content such as voice, data, video, messaging, broadcast, or the like to multiple users. For example, the network 103 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 103 may comprise other networks such as a core network, the Internet, a sensor network, an industrial control network, a personal area network, a fused personal network, a satellite network, a home network, or an enterprise network for example.

Client device 101 in one example is operated by a user who would like to consume media from server 105. Accordingly, user will utilize client device 101 to establish contact with server 105 over network 103. The user will then request the desired media from server 105 and the server 105 will process and transmit the desired media to user device in accordance with the principles described herein.

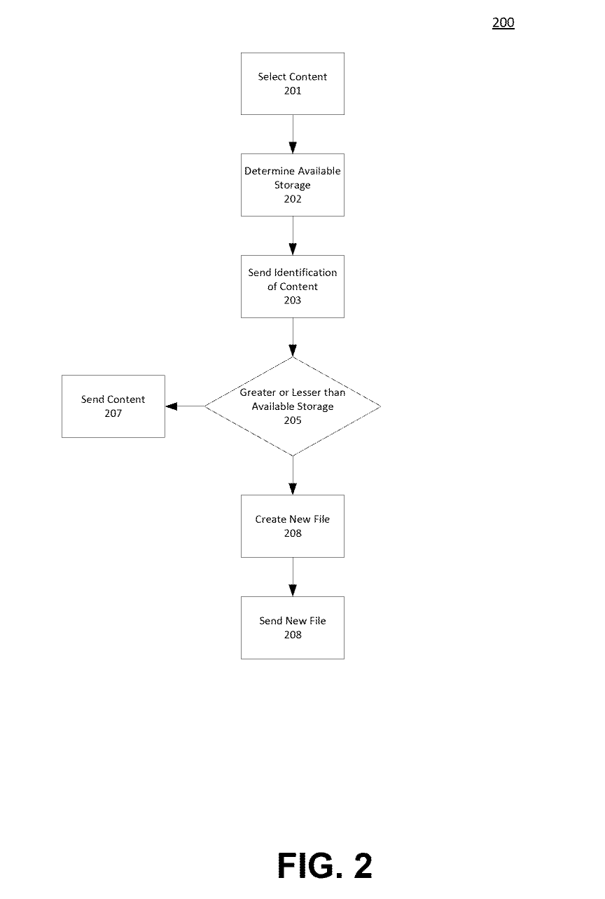

Referring to FIG. 2, an exemplary embodiment of a method 200 for enhanced transmission of media to a client device 101 is now described for illustrative purposes.

In step 201, a user employs client device 101 to select content that the user would like to download from server 105. The content may be listed through the use of an application on device 101 that exchanges data with server 105 such that available content from server 105 may be listed on device 101. The content in one example is one or more media files, but this disclosure is not limited to media files. In one embodiment, the multiple versions of the content may be listed. For instance, there may be versions that have different file sizes or may have different display formats.

In step 202, client device 101 determines the storage that it has available. In one example, such storage may include all available storage on device 101. In another example, such storage may include storage that is available provided that user contingently deletes certain unnecessary or unwanted files. For instance, user may be prompted in step 201 if user wishes to delete unwanted or unnecessary files from server 105. In another example, the user may specify a maximum amount of storage that it wants to devote to media, and therefore device 101 would calculate the maximum amount minus whatever other media it has in storage.

In step 203, client device 101 sends the server 103 an identification of the content that user wants to download from server 105. The content may include a single file or multiple files. In step 203, client device 101 also transmits the available storage on device to server 105. In another embodiment, client device 101 may transmit the available storage before or after it sends the content that user wants to download from server 105. In one embodiment, client device 101 may also send certain device parameters to server 105. Such device parameters may include information, such as device resolution, preferred file formats, optimal balance between the size of a requested file and the resolution (user may elect a smaller file as long as it provides minimum resolution), etc.

In step 205, server 105 locates the requested file(s) and determines whether or not the file(s) are greater or lesser in size than the available storage on client device 101. If the file(s) are lesser in size, then in step 207 the server 105 sends the file(s) to client device 101 for download. In one embodiment, server 105 may have multiple versions of each of the requested file(s). In one example, versions may each be of a different size. In such an instance, the server 105 may elect to send the largest version that fits within the available storage on device 101. In another example, the server 105 may elect to send the version that it calculates will provide the highest quality resolution on device 101 given the device parameters.

If in step 205, server 105 does not locate versions of the file(s) that fit within the available space and/or meet device parameters, server 105 will identify a version of the file(s) that it does have within its memory and, in step 208, create a version of file that does meet the available space requirement and/or device parameters. In one embodiment, server 105 creates such file(s) by adjusting the bitrate of files such that size of the file meets the available space of device 101. In one example, server 105 adjusts the bit rate through utilization of two-pass encoding.

In step 209, server 105 sends the requested file(s) to device 101.

FIG. 3 illustrates an example block diagram of a system 300 for carrying out aspects of method 200. System 300 includes client 302, network 304, and server 306. While illustrated as separate components, other arrangements can be employed without departing from the scope of the disclosure

FIG. 3 is a block diagram of network device 300 that may be connected to or comprise a component or components shown in FIG. 1. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an ALFS, a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations described herein. As evident from the description herein, network device 300 is not to be construed as software per se.

In addition to processor 302 and memory 304, network device 300 may include an input/output system 306. Processor 302, memory 304, and input/output system 306 may be coupled together to allow communications therebetween. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof 3emory 504 may include additional storage (e.g., a removable storage 318 or a nonremovable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

More, while aspects herein are generally directed to adaptive bitrate streaming video, it is understood that the techniques described herein can be utilized in any environment where content sources can be streamed, and particularly where data is stream-able at varying qualities, rates, or in differing versions. While exemplary embodiments have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with streaming systems and methods as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing content delivery as described herein. When implemented on a general-purpose processor, the program code combines with the processor to provide a unique device that operates to invoke the functionality of a streaming system.

While streaming systems and methods have been described in connection with the various examples of the various figures, it is to be understood that other similar implementations may be used or modifications and additions may be made to the described examples of a streaming system or method without deviating therefrom. For example, one skilled in the art will recognize that a streaming system as described in the instant application may apply to any environment, whether wired or wireless, and may be applied to any number of such devices connected via a communications network and interacting across the network. Therefore, streaming systems and methods as described herein should not be limited to any single example, but rather should be construed in breadth and scope in accordance with the appended claims.

What is claimed is:

1. A method, comprising:
receiving a request from a client device to stream at least one media file, wherein the request has an associated client storage parameter;
identifying the at least one media file in a memory storage device;
determining whether or not the at least one media file satisfies the client storage parameter;
if the at least one media file does not satisfy the client storage parameter, generating another media file that does satisfy the client storage parameter; and
sending one of the at least one media file and the other media file in accordance with determining if the at least one media file satisfies the client storage parameter.

2. The method of claim 1, further comprising:
receiving the client storage parameter from the client device.

3. The method of claim 2, wherein the client storage parameter comprises available storage on the client device.

4. The method of claim 1, wherein the step of generating comprises:
locating a version of the at least one media file in the memory storage device that does satisfy the client storage parameter.

5. The method of claim 1, wherein the step of generating comprises:
using the at least one media file to create the other media file.

6. The method of claim 1, wherein the step of using comprises:
encoding the at least one media file at a reduced bit rate.

7. The method of claim 6, wherein the step of encoding comprises:
employing two pass encoding.

8. A system, including:
a media server run by a processor and stored on a non-transitory computer readable medium, the media server including:
a module that receives a request from a client device to stream at least one media file, wherein the request has an associated client storage parameter;
a module that identifies the at least one media file in a memory storage device;
a module that determines whether or not the at least one media file satisfies the client storage parameter; and
a module that generates another media file that does satisfy the client storage parameter if the at least one media file does not satisfy the client storage parameter; and
a module that sends one of the at least one media file and the other media file in accordance with determining if the at least one media file satisfies the client storage parameter.

9. The system of claim 8, wherein the module that receives obtains the client storage parameter from the client device.

10. The system of claim 9, wherein the client storage parameter comprises available storage on the client device.

11. The system of claim 8, wherein the module that generates locates a version of the at least one media file in the memory storage device that does satisfy the client storage parameter.

12. The system of claim 8, wherein the module that generates uses the at least one media file to create the other media file.

13. The system of claim 8, wherein the module that generates:
encodes the at least one media file at a reduced bit rate.

14. The system of claim 13, the module that generates employs two pass encoding.

15. A system, including:
a device including a processor and instructions stored on a non-transitory computer readable medium, the instructions when executed perform a method including:
receiving a request from a client device to stream at least one media file, wherein the request has an associated client storage parameter;
identifying the at least one media file in a memory storage device;
determining whether or not the at least one media file satisfies the client storage parameter;
if the at least one media file does not satisfy the client storage parameter, generating another media file that does satisfy the client storage parameter; and
sending one of the at least one media file and the other media file in accordance with determining if the at least one media file satisfies the client storage parameter.

16. The system of claim 15, wherein the client storage parameter is received from the client device.

17. The system of claim 16 wherein the client storage parameter comprises available storage on the client device.

18. The system of claim 15, wherein the instructions for generating comprise instructions for locating a version of the at least one media file in the memory storage device that does satisfy the client storage parameter.

19. The system of claim 15, wherein the instructions for generating use the at least one media file to create the other media file.

20. The system of claim 19, wherein the instructions for generating employ two pass encoding to create the other media file.
